(19) United States
(12) Patent Application Publication
(10) Pub. No.: US 2006/0129990 A1
(43) Pub. Date: Jun. 15, 2006

(54) System, method, and article of manufacture for determining execution counts associated with a software program of an embedded system

(75) Inventors: John R. Flanagan, Poughkeepsie, NY (US); Ronald K. McMurdy, Poughkeepsie, NY (US)

Correspondence Address: Philmore H. Colburn II;Cantor Colburn LLP, 55 Griffin Road South, Bloomfield, CT, 06002, US

(73) Assignee: INTERNATIONAL BUSINESS MACHINES CORPORATION, ARMONK, NY (US)

(21) Appl. No.: 11/010,885

(22) Filed: Dec. 13, 2004

(51) Int. Cl. G06F 9/44

(52) U.S. Cl. 717/124

(57) ABSTRACT

A system, method, and article of manufacture for determining execution counts associated with a first plurality of software commands in a first software program of an embedded system are provided. The method includes accessing a memory having a plurality of software test cases utilizing a computer. The method further includes executing the first software program using an embedded system simulation program and the plurality of software test cases. The plurality of software test cases are configured to induce the first software program to execute at least a portion of the first plurality of software commands. The method further includes calculating a plurality of execution counts wherein each execution count corresponds to a number of times each software command of the first plurality of software commands is executed when executing the first software program.

### FIELD OF INVENTION

The invention relates to a system, a method, and an article of manufacture for determining execution counts associated with a software program of an embedded system.

### BACKGROUND OF INVENTION

In an embedded system, one or more embedded processors are integrated into a product for the purpose of controlling hardware or providing additional functionality. Each processor executes a software program comprising a plurality of software commands. Portions of the plurality of software commands that are frequently executed are referred to as mainline software commands. Portions of the plurality of software commands that are infrequently executed are referred to as non-mainline software commands.

Because a software compiler and linker for an embedded processor is not able to identify the software commands that are frequently executed from those software commands that are infrequently executed, the compiler and linker does not compile the software commands such that the frequently executed software commands are initially stored in a cache resident on a processor microchip. Accordingly, portions of the frequently executed software commands are stored in caches external to the processor microchip. Similarly portions of the infrequently executed software commands may be stored in the cache resident on the processor microchip. Thus, when executing the frequently executed software commands, the processor retrieves portions of the frequently executed software commands stored on the external caches, which substantially delays the execution of the software commands due to the relatively large retrieval delay time of the external caches.

Accordingly, there is a need for a system and a method for identifying frequently executed software commands in a plurality of software commands utilized by an embedded processor for grouping the frequently executed software commands together in a cache resident on an embedded processor.

### SUMMARY OF INVENTION

A system for determining execution counts associated with a first plurality of software commands in a first software program of an embedded system in accordance with an exemplary embodiment is provided. The system includes a memory having a plurality of software test cases. The system further includes a computer operably coupled to the memory. The computer has an embedded system simulation program configured to execute the first software program using the plurality of software test cases. The plurality of software test cases are configured to induce the first software program to execute at least a portion of the first plurality of software commands. The computer is further configured to calculate a plurality of execution counts wherein each execution count corresponds to a number of times each software command of the first plurality of software commands is executed when executing the first software program.

A method for determining execution counts associated with a first plurality of software commands in a first software program of an embedded system in accordance with another exemplary embodiment is provided. The method includes accessing a memory having a plurality of software test cases utilizing a computer. The method further includes executing the first software program using an embedded system simulation program and the plurality of software test cases. The plurality of software test cases are configured to induce the first software program to execute at least a portion of the first plurality of software commands. The method further includes calculating a plurality of execution counts wherein each execution count corresponds to a number of times each software command of the first plurality of software commands is executed when executing the first software program.

An article of manufacture in accordance with another exemplary embodiment is provided. The article of manufacture includes a computer storage medium having a computer program encoded therein for determining execution counts associated with a first plurality of software commands in a first software program of an embedded system. The computer storage medium includes code for accessing a memory having a plurality of software test cases utilizing a computer. The computer storage medium further includes code for executing the first software program using an embedded system simulation program and the plurality of software test cases. The plurality software test cases are configured to induce the first software program to execute at least a portion of the first plurality of software commands. The computer storage medium further includes code for calculating a plurality of execution counts wherein each execution count corresponds to a number of times each software command of the first plurality of software commands is executed when executing the first software program.

Other systems and methods according to the embodiments will be or become apparent to one with skill in the art upon review of the following drawings and detailed description. It is intended that at all such additional systems and methods be within the scope of the present invention, and be protected by the accompanying claims.

### BRIEF DESCRIPTION DRAWINGS

FIG. 1 is a block diagram of an embedded system;

FIG. 2 depicts a system for determining execution counts associated with a first plurality of software commands for the embedded system of FIG. 1;

FIG. 3 is a block diagram depicting the first plurality of software command comprising mainline software blocks and non-mainline software blocks; and

FIG. 4 is a method for determining execution counts associated with the first plurality of software commands.

### DESCRIPTION OF AN EMBODIMENT

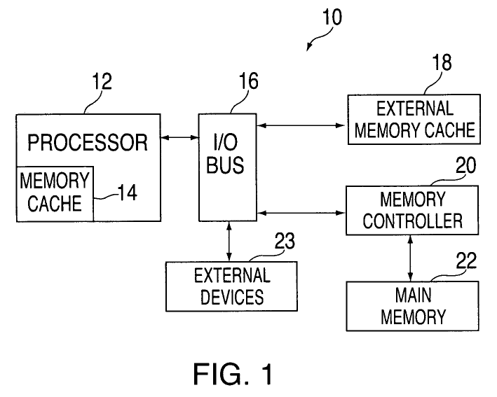

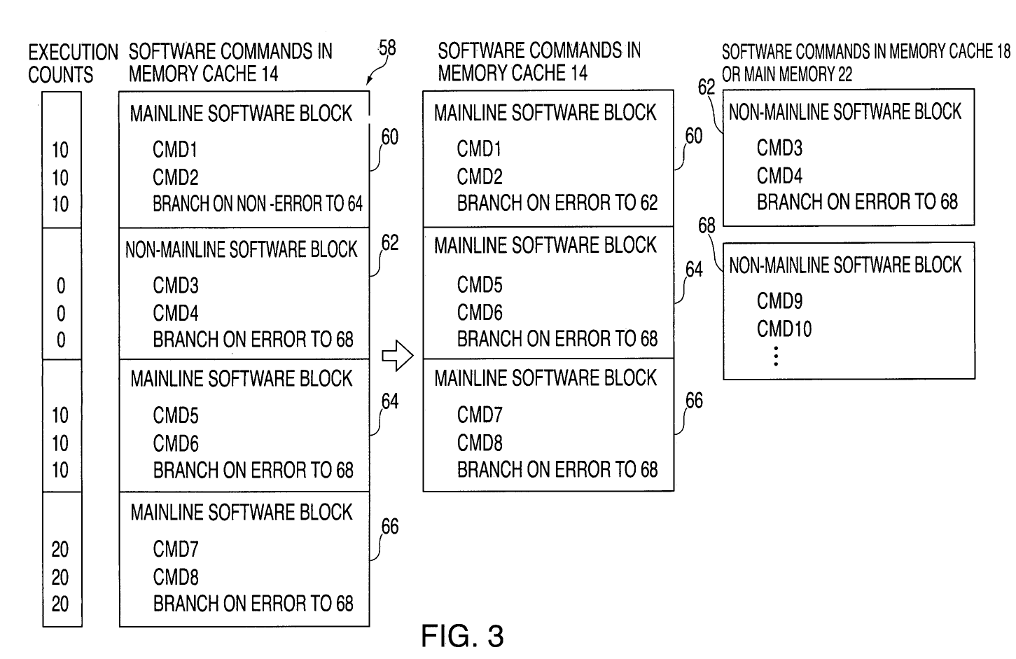

Referring to FIGS. 1 and 3, an embedded system 10 is illustrated. The embedded system 10 executes a plurality of software commands 58 for performing tasks. Before explaining a system for determining execution counts associated with the plurality of software commands 58, a brief explanation of the embedded system 10 will be provided.

The embedded system 10 includes a processor 12 having a memory cache 14, and input/output (I/O) bus 16, and an external memory cache 18, a memory controller 20, a main memory 22, and external devices 23. The processor 12 is provided to execute software commands stored in the memory cache 14 to control operation of the external devices 23. The processor 12 also retrieves software commands stored in the memory cache 18 and the main memory 22 and loads the software commands in the memory cache 14 for executing the software commands therein. The processor 12 is operably coupled to the I/O bus 16. The I/O bus 16 is further operably coupled to the external memory cache 18 and to the memory controller 20. The memory controller 20 is further operably coupled to the main memory 22.

When the processor 12 needs to access software commands stored in the external memory cache 18, the processor 12 sends a retrieval request message through the I/O bus 16 to the memory cache 18. In response to the retrieval request message, the memory cache 18 transfers the requested software commands to the processor 12. Thereafter, the processor 12 loads the retrieved software commands within the memory cache 14. Further, when the processor 12 needs to access software commands stored in the main memory 22, the processor 12 sends a retrieval request message through the I/O bus 16 to the memory controller 20. In response to the retrieval request message, the memory controller 20 retrieves the requested software commands from the main memory 22 and transfers the software commands to the processor 12 through the I/O bus 16. Thereafter, the processor 12 loads the retrieved software commands within the memory cache 14 for execution therein.

The inventors herein have recognized that mainline software commands that are frequently executed by the processor 12 should be stored within the memory cache 14 during execution of the software commands. Thus, the embedded system 10 can operate efficiently when executing the mainline software commands without having to repeatedly access the external memory cache 18 and the main memory 22 for mainline software commands. The methodology for determining the mainline software commands utilizing execution counts will be described in greater detail below.

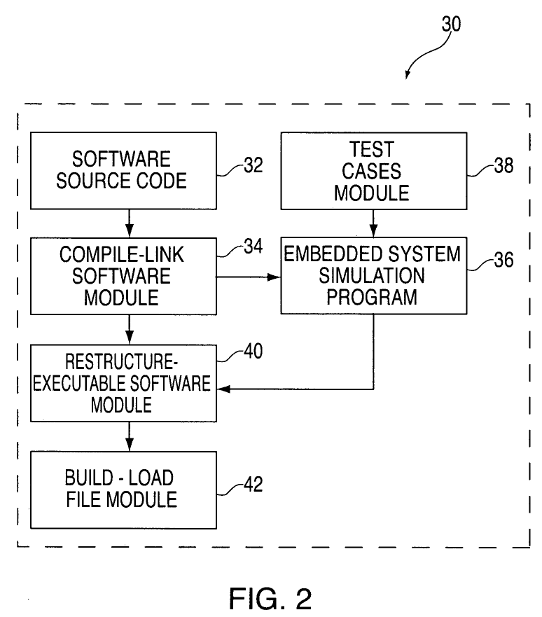

Referring to FIGS. 2 and 3, a system 30 for determining execution counts associated with a first plurality of software commands in a first software program of an embedded system is illustrated. The individual modules and program of the system 30 are embodied within a single computer. In an alternate embodiment, however, the individual modules and program can be embodiment in a plurality of computers. The system 30 includes software source code 32, a compile-link software module 34, an embedded system simulation program 36, a test cases module, a restructure executable software module 40, and a build-load file module 42.

The software source code 32 is provided to store the plurality of software commands 58 that are to be executed by the embedded system 10. The software source code 32 comprises files containing the plurality of software commands or source code 58. For example, in one embodiment, the plurality of software commands 58 are segmented into software blocks 60, 62, 64, and 66. Further, each software block comprises a portion of the plurality of software commands 58. Each software block is defined as the software commands between branching commands, wherein each branching command alters the sequential execution of the software commands. For example, the mainline software block 60 includes a CMD1 software command, a CMD2 software command, and a first conditional Branch command. The non-mainline software block 62 includes a CMD3 software command, a CMD4 software command, and a second conditional Branch command. The mainline software block 64 includes a CMD5 software command, a CMD6 software command, and a third conditional Branch command. Finally, the mainline software block 66 includes a CMD7 software command, a CMD8 software command, and a fourth conditional Branch command. Further, it should be noted that when a mainline software block is executed, substantially all of the software commands within the software block are executed. The software command can comprise either high-level software commands or assembly language software commands.

The compile-link software module 34 is provided to compile and link the plurality of software commands 58 into an executable file. The compile-link software module 34 operably communicates with the software source code 32, the embedded system simulation program 36, and the restructure-executable software module 40. After compiling the plurality of software commands 58, the module 34 transfers the executable file to both the embedded system simulation program 36 and to the restructure-executable software module 40.

The embedded system simulation program 36 is provided to execute the executable file containing the plurality of software commands 58 utilizing the test cases stored in the test cases module 38. The test cases are utilized to induce the program 36 to execute portions of the plurality of software commands 58 that comprise the mainline software commands. In particular, test cases induce the embedded system simulation program 36 to execute commands in the code block 60, 64, and 66. The embedded system simulation program 36 is further provided to determine an execution count for each software command in the plurality of software commands 58. In particular, the program 36 increments each execution count associated with each of the software commands each time the software command is executed. For example, after executing the test cases, the execution counts associated with the software commands and software block 60 have an execution count equal to “10” indicating that each of the commands were executed 10 times. After utilizing the test cases to execute portions of the plurality of software commands 58, the embedded system simulation program 36 transfers each of the execution counts associated with each of the software commands of the plurality of software commands 58 to the restructure-executable software module 40.

The restructure-executable software module 40 is provided to receive the executable file of the plurality of software commands 58 and the execution counts associated with the software commands 58. The module 40 is further provided to restructure the sequence of the compiled software commands such that the software commands having the greatest execution counts are loaded within the memory cache 14 and the software commands having the lowest execution counts are loaded within either memory cache 18 or the main memory 22 during execution of the software commands. For example, the module 40 can receive an executable file containing software blocks 60, 62, 64, 66. The software commands in the blocks 60, 64, 66 have execution counts equal to the values “10”, “10”, “20”, respectively, which are indicative of mainline software commands. The software commands in the block 62 have execution counts equal to the value “0”, which is indicative of non-mainline software commands. Accordingly, the module 40 groups together the software commands in the software blocks 60, 64, 66 for storage in the memory cache 14. Further, the module 40 separates the software block 62 from the blocks 60, 64, 66 for storage in either the memory cache 18 or the main memory 22. Thereafter, the module 40 transfers the reordered executable file to the build-load file module 42.

The build-load file module 42 is provided to package the restructured executable software commands for loading the software commands into the main memory 22.

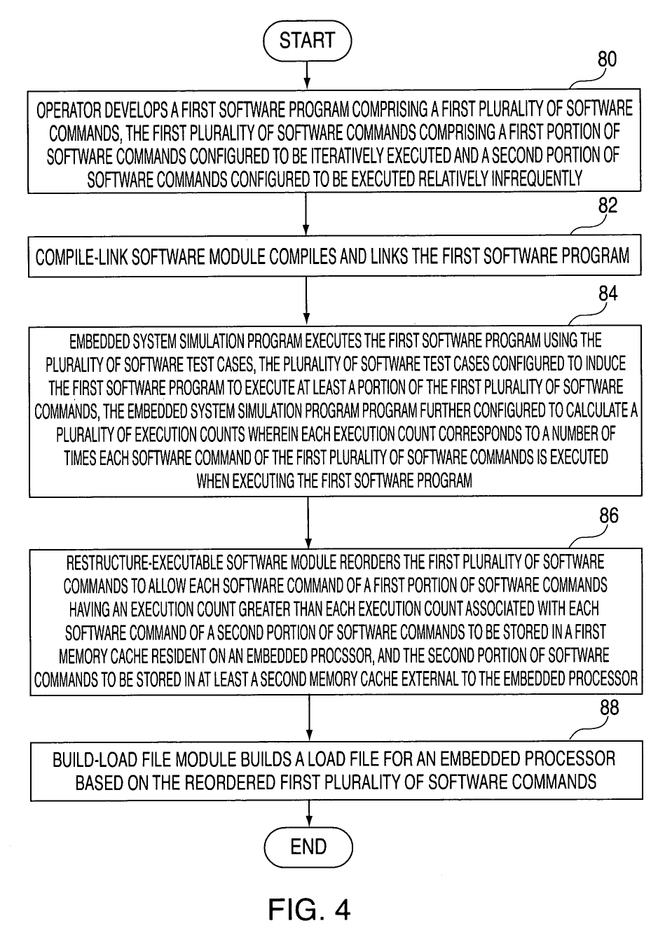

Referring to FIG. 4, a method for determining execution counts associated with the plurality of software commands 58 associated with the embedded system 10 will now be described.

At step 80, and operator develops a first software program comprising the plurality of software commands 58, the plurality of software commands 58 comprising a first portion of software commands configured to be executed frequently and a second portion of software commands configured to be executed relatively infrequently.

At step 82, the compile-link software module 34 compiles and links first software program.

At step 84, the embedded system simulation program 36 executes the first software program using the plurality of software test cases, the software test cases configured to induce the first software program to execute at least a portion of the plurality of software commands 58. The embedded system simulation program 36 further calculates a plurality of execution counts wherein each execution count corresponds to a number of times each software command of the plurality of software commands 58 is executed when executing the first software program.

At step 86, the restructure-executable software module reorders the first plurality of software commands to allow each software command of a first portion of software commands having an execution count greater than each execution count associated with each software command of a second portion of software commands to be stored in a first memory cache resident on an embedded processor, and the second portion of software commands to be stored in at least a second memory cache external to the embedded processor 12.

At step 88, the build-load file module builds a load file for an embedded processor 12 based on the reordered plurality of software commands 58.

The system and method for determining execution counts associated with a plurality of software commands of an embedded system provides a substantial advantage over other systems and methods. In particular, the system and method provides a technical effect of generating execution counts of embedded software commands utilizing an embedded system simulation program to determine mainline software commands and non-mainline software commands for the embedded system.

While the invention is described with reference to an exemplary embodiment, it will be understood by those skilled in the art that various changes may be made an equivalence may be substituted for elements thereof without departing from the scope of the invention. In addition, many modifications may be made to the teachings of the invention to adapt to a particular situation without departing from the scope thereof. Therefore, is intended that the invention not be limited the embodiment disclosed for carrying out this invention, but that the invention includes all embodiments falling with the scope of the intended claims. Moreover, the use of the term's first, second, etc. does not denote any order of importance, but rather the term's first, second, etc. are us are used to distinguish one element from another.

What is claimed is:

1. A system for determining execution counts associated with a first plurality of software commands in a first software program of an embedded system, comprising:
a memory having a plurality of software test cases; and
a computer operably coupled to the memory, the computer having an embedded system simulation program configured to execute the first software program using the plurality of software test cases, the plurality of software test cases configured to induce the first software program to execute at least a portion of the first plurality of software commands, the computer further configured to calculate a plurality of execution counts wherein each execution count corresponds to a number of times each software command of the first plurality of software commands is executed when executing the first software program.

2. The system of claim 1, wherein the computer is further configured to compile and link the first plurality of software commands.

3. The system of claim 2, wherein the computer is further configured to reorder the first plurality of software commands to allow each software command of a first portion of software commands having an execution count greater than each execution count associated with each software command of a second portion of software commands to be stored in a first memory cache resident on an embedded processor, and the second portion of software commands to be stored in at least a second memory cache external to the embedded processor.

4. The system of claim 1, wherein the first plurality of software commands comprises high-level software commands for the embedded system.

5. The system of claim 1, wherein the first plurality of software commands comprises assembly language software commands for the embedded system.

6. A method for determining execution counts associated with a first plurality of software commands in a first software program of an embedded system, the method comprising:
accessing a memory having a plurality of software test cases utilizing a computer;
executing the first software program using an embedded system simulation program and the plurality of software test cases, the plurality of software test cases configured to induce the first software program to execute at least a portion of the first plurality of software commands; and
calculating a plurality of execution counts wherein each execution count corresponds to a number of times each software command of the first plurality of software commands is executed when executing the first software program.

7. The method of claim 6, further comprising compiling and linking the first plurality of software commands.

8. The method of claim 7, further comprising:
reordering the first plurality of software commands to allow each software command of a first portion of software commands having an execution count greater than each execution count associated with each software command of a second portion of software commands to be stored in a first memory cache resident on an embedded processor, and the second portion of software commands to be stored in at least a second memory cache external to the embedded processor.

9. The method of claim 6, wherein the first plurality of software commands comprises high-level software commands for the embedded system.

10. The method of claim 6, wherein the first plurality of software commands comprises assembly language software commands for the embedded system.

11. An article of manufacture, comprising:
a computer storage medium having a computer program encoded therein for determining execution counts associated with a first plurality of software commands in a first software program of an embedded system, the computer storage medium including:
code for accessing a memory having a plurality of software test cases utilizing a computer;
code for executing the first software program using an embedded system simulation program and the plurality of software test cases, the plurality of software test cases configured to induce the first software program to execute at least a portion of the first plurality of software commands; and
code for calculating a plurality of execution counts wherein each execution count corresponds to a number of times each software command of the first plurality of software commands is executed when executing the first software program.

12. The article of manufacture of claim 11, further comprising code for compiling and linking the first plurality of software commands.

13. The article of manufacture of claim 11, further comprising code for reordering the first plurality of software commands to allow each software command of a first portion of software commands having an execution count greater than each execution count associated with each software command of a second portion of software commands to be stored in a first memory cache resident on an embedded processor, and the second portion of software commands to be stored in at least a second memory cache external to the embedded processor.

14. The article of manufacture of claim 11, wherein the first plurality of software commands comprises high-level software commands for the embedded system.

15. The article of manufacture of claim 11, wherein the first plurality of software commands comprises assembly language software commands for the embedded system.
